(19) United States
(12) Patent Application Publication
(10) Pub. No.: US 2006/0251469 A1
(43) Pub. Date: Nov. 9, 2006

(54) Folding slider joint for elongated structures

(76) Inventor: Tadd M. McBride, Riverton, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/414,938

(22) Filed: May 1, 2006

Related U.S. Application Data
(60) Provisional application No. 60/678,993, filed on May 9, 2005.

(51) Int. Cl. F16C 11/00; F16D 1/12

(52) U.S. Cl. 403/100

(57) ABSTRACT

Embodiments of the present invention include a folding slider joint for selective folding or collapsing of an elongated structural member. Various embodiments of the folding slider joint may include end caps for ends of the elongated members, the end caps configured for dual pivoting linkage with each other, a hollow slider configured for sliding over the end caps in the ends of the elongated members, optional slider stops and optional detent locking mechanisms. Methods of operating the folding slider joint are also disclosed.

### CROSS-REFERENCE TO RELATED APPLICATIONS

This nonprovisional patent application claims benefit and priority under 35 U.S.C. § 119(e) of the filing of U.S. Provisional Patent Application Ser. No. 60/678,993 filed on May 9, 2005, titled “PORTABLE, WATERPROOF WATERFOWL LAYOUT BLIND, FRAMEWORK AND COLLAPSIBLE ROOF FLAP JOINTS,” the contents of which are expressly incorporated herein by reference for all purposes.

### BACKGROUND OF THE INVENTION

1. Field of the Invention

This invention relates generally to mechanisms for folding or collapsing elongated structures. More particularly, the invention relates to a folding slider joint for elongated structures.

2. Description of Related Art

Elongated members, particularly poles, find use in many applications, e.g., tent poles, sun shade umbrellas and cleaning tools. Such elongated members are known to be made of various materials including wood, fiberglass, aluminum and steel. It is frequently desirable to be able to collapse or fold elongated members for compact travel or storage or when otherwise not in use. In order to accommodate such a feature, various approaches have been taken in the art to provide a joint or other mechanism that allows for elongated members to be collapsed or folded.

One example is the use of an aluminum sleeve attached to the outer end of a fiberglass tent pole. In order to create a long tent pole, several sections of poles could be placed end-on-end by inserting a fiberglass pole end into an adjacent pole with an affixed sleeve, typically with a friction fit. When the long tent pole was no longer needed, it could be readily disassembled and the pole sections stored together in parallel for compact transport. However, one disadvantage with this conventional pole joint technology is that the long tent pole had a tendency to come apart during assembly and insertion into tent sleeves. The other disadvantage relates to ascertaining the number of sections are needed for a given long pole.

Another approach to joints for folding tent poles is hollow aluminum poles in sections each configured with a reduced diameter end to fit inside the hollow end of an adjacent section. The aluminum poles have generally become preferred over fiberglass because it is lighter weight material. The shoulder formed in the reduced diameter end of each aluminum pole section provides a stop for the adjacent pole section with an end having a regular inside diameter. Thus, no special insert for a pole joint is necessary. For many applications, a simple friction fit to such joints is adequate. However, there still remained the problem of assembling the various pole sections and determining how many sections were necessary for a given pole to be constructed.

One approach to solving this problem in joints for folding tent poles is the well known hollow aluminum poles that have a shock-cord in the hollow interior at joint sections. This solution provides a bias to hold the pole sections together at any given joint and clearly defines the adjacent sections of a given long pole structure. The shock-cord could be limited to each joint section with a special end cap, see e.g., U.S. Pat. No. 5,683,199 to Tehan. Alternatively, the shock-cord has been configured to run the entire length of the complete pole and throughout each pole section. One disadvantage with shock-corded pole joints, friction fit or otherwise, is that they cannot be used in tension. This may or may not be a problem depending on the particular application of the poles and the associated joints.

A variation on the shock-cord themed pole joint solution is disclosed in U.S. Pat. No. 5,590,674 to Eppenbach. The Eppenbach patent discloses a spring sleeve designed to fit around both ends of two elongated members, one of the ends having a male section for insertion into an adjoining female pole end. The sleeve is affixed to both ends of the pole sections to be joined and the joint is at all times covered by the spring sleeve. Disadvantages of the Eppenbach joint may include the long-term wear characteristics of the spring sleeve, use in tension and the significantly increased cross-sectional area of the joint. This latter problem is particularly noticeable in the tent pole application where the tent pole is designed to be threaded through sleeves of a tent as the protruding joints would tend to catch on the sleeves as they are threaded through the sleeves during tent erection.

Still another conventional pole joint is disclosed in U.S. Pat. No. 6,200,060 to Vernay. The Vernay joint includes two plastic end caps for insertion into ends of the two elongated members to be joined. The end caps of the Vernay joint allow separation of the two elongated members and also allow a joint to be formed in between them. However, the Vernay joint is only as strong as the plastic used to form the end caps and does not appear to take advantage of the structural strength of the elongated members themselves. Finally, the Vernay joint cannot be used in tension because tension is used to unlock the Vernay pole joint.

Thus, it would be highly advantageous to provide a joint for selectively joining elongated members that retains the structural strength of the elongated members, even at the joint. It would further be advantageous if such a joint were capable of being used in tension, inexpensive to manufacture and simple to operate as well.

### SUMMARY OF THE INVENTION

An embodiment of a folding slider joint for rigidly joining two elongated members is disclosed. The folding slider joint may include two end caps configured for placement on ends of the two elongated members and configured for dual pivoting linkage with each other. The folding slider joint may further include a hollow slider comprising an inside dimension configured for concentrically surrounding the elongated members and end caps in a rigid deployed position.

An embodiment of a method of deploying a folding slider joint between two elongated members is also disclosed. The method may include providing a folding slider as described above and elsewhere herein. The method may further include sliding the hollow slider over the two end caps between the two elongated members of the folding slider joint.

An embodiment of a method of collapsing a deployed folding sliderjoint between two elongated members is also disclosed. The method may include providing a folding slider joint as described above and elsewhere herein. The method may further include optionally unlocking the hollow slider over the two end caps between the two elongated members. The method may further include sliding the hollow slider off of the folding slider joint and onto one of the two elongated members. The method may further include optionally folding the two elongated members at the dual pivoting linkage.

Additional features and advantages of the invention will be set forth in the description which follows, and in part will be apparent from the description, or may be learned by the practice of the present invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a perspective view of an embodiment of a folding slider joint with detent mechanisms in a rigid deployed position according to the present invention.

FIG. 2 is a perspective view of an embodiment of a folding slider joint without detent mechanisms in a rigid deployed position according to the present invention.

FIG. 3 is a perspective view of an embodiment of a folding slider joint without detent mechanisms in a folded position according to the present invention.

FIG. 4 is a perspective view of an embodiment of a folding slider joint with detent mechanisms in a folded position according to the present invention.

FIG. 5 is a flow chart of a method of deploying a folding sliderjoint between two elongated members.

FIG. 6 is a flow chart of a method of collapsing a deployed folding slider joint between two elongated members.

### DETAILED DESCRIPTION OF THE INVENTION

The invention is a folding slider joint for joining two elongated members (e.g., segments of poles) and methods for deploying and collapsing same. Embodiments of the folding slider joint may be used to join segments of elongated members used in many different applications. For example and not by way of limitation, folding slider joints may find application in tent poles, sun shade umbrellas, hunting blinds (layout, ground and boat), folding outdoor furniture, awnings, shelters, backpack frames, cleaning and tree pruning tools, fishing spears and other pronged poles and portable tools such as shovels. Such elongated members may be solid or hollow. Furthermore, such elongated members suitable for use with the embodiments of a folding slider joint consistent with the present invention may be made of various materials including wood, fiberglass, aluminum, titanium or steel.

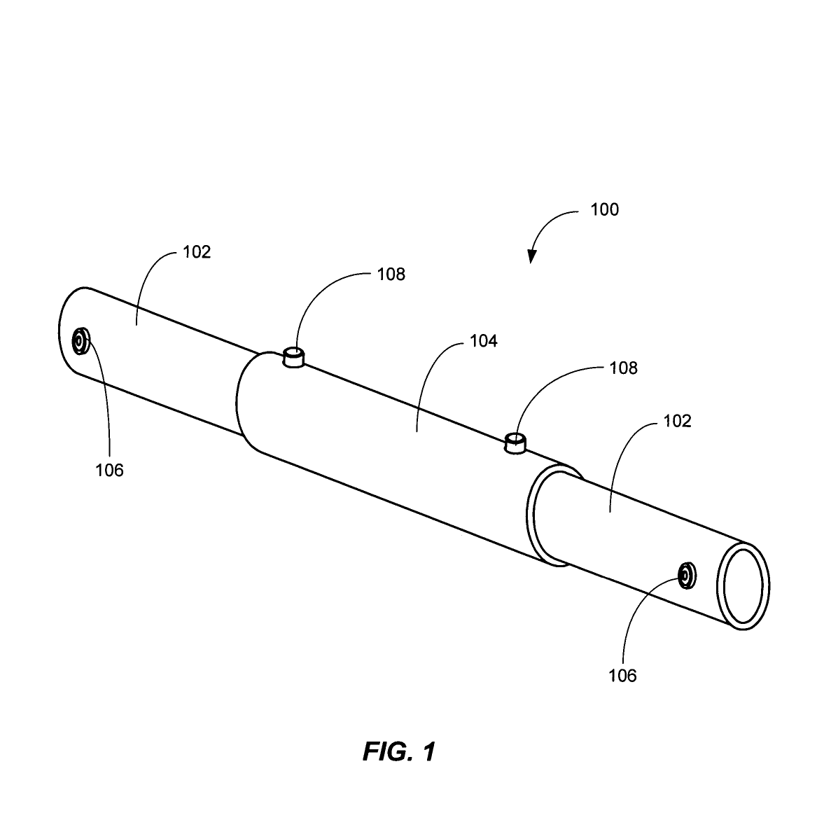

FIG. 1 is a perspective view of an embodiment of a folding slider joint 100 with detent mechanisms 108 in a rigid deployed position according to the present invention. Folding slider joint 100 may include two elongated members 102, the ends of which (not visible in FIG. 1) are joined at the folding slider joint 100. Folding slider joint 100 may also include a hollow slider 104 configured to slide over the two elongated members 102.

Folding slider joint 100 may also include one or two slider travel stops 106 (two shown in FIG. 1) according to an embodiment of the present invention. Each slider travel stop 106 is configured to protrude from the surface of an elongated member and abut an end of the hollow slider 104 at a point where it is desired to halt further movement of the hollow slider 104. Slider travel stops 106 limit the distance along the surface of a given elongated member 102 over which the hollow slider 104 may travel. Still further embodiments of folding slider joint 100 may include one or more detent mechanisms 108 for locking the hollow slider 104 in various positions, such as the rigid deployed position illustrated in FIG. 1.

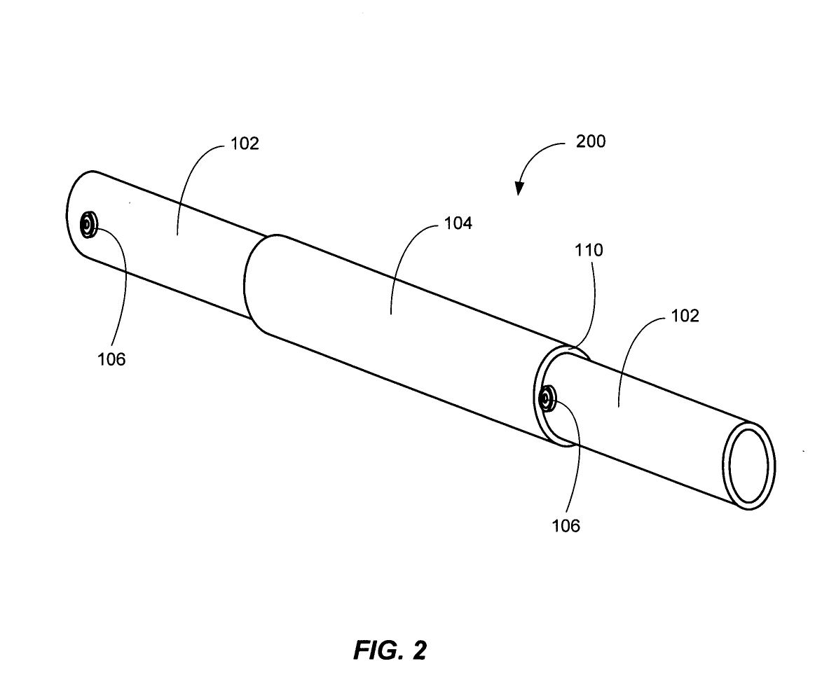

FIG. 2 is a perspective view of an embodiment of a folding slider joint 200 without detent mechanisms 108 (see FIG. 1) in a rigid deployed position according to the present invention. FIG. 2 shows two elongated members 102 each having slider travel stops 106, one of which abuts an end 110 of hollow slider 104. This embodiment of a folding slider joint 200 may have a friction fit to hold the hollow slider 104 over the ends (hidden by hollow slider 104) of the two elongated members 102.

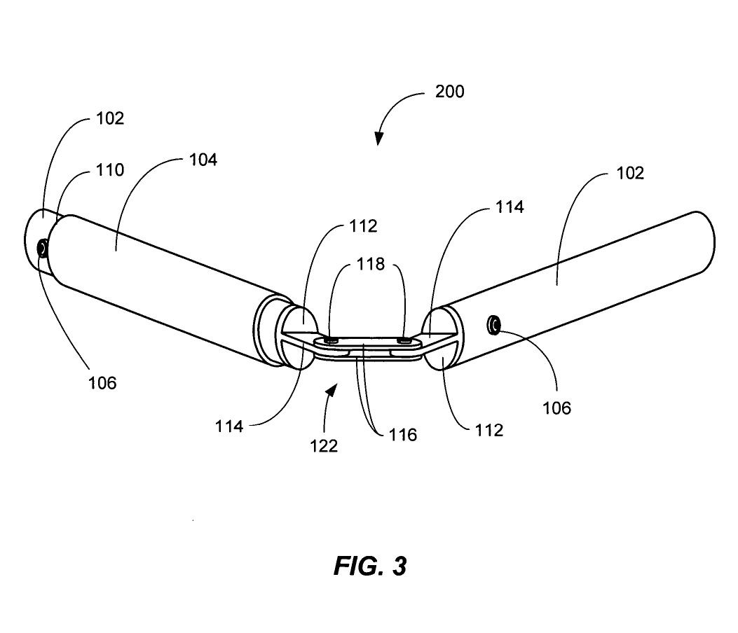

FIG. 3 is a perspective view of an embodiment of a folding slider joint 200 without detent mechanisms 108 (see FIG. 1) in a folded position according to the present invention. The folding slider joint 200 illustrated in FIG. 3 includes two elongated members 102 and a hollow slider 104. FIG. 3 further shows the dual pivot mechanism of the folding slider joint 200. Two end caps 112 are disposed at the ends of the two elongated members 102. Each end cap 112 may have a tab 114 extending from the base of end cap 112. A distal end of each tab 114 may contain a hole for receiving a binding member such as binding screw 118. Folding slider joint 200 may further include at least one linking member 116 (two shown in FIG. 3). Binding screws 118 may be used to secure linking members 116 to end cap 112 tabs 114. Thus, the dual pivot mechanism of folding slider joint 200 is comprised of tabs 114, linking members 116 and binding screws 118.

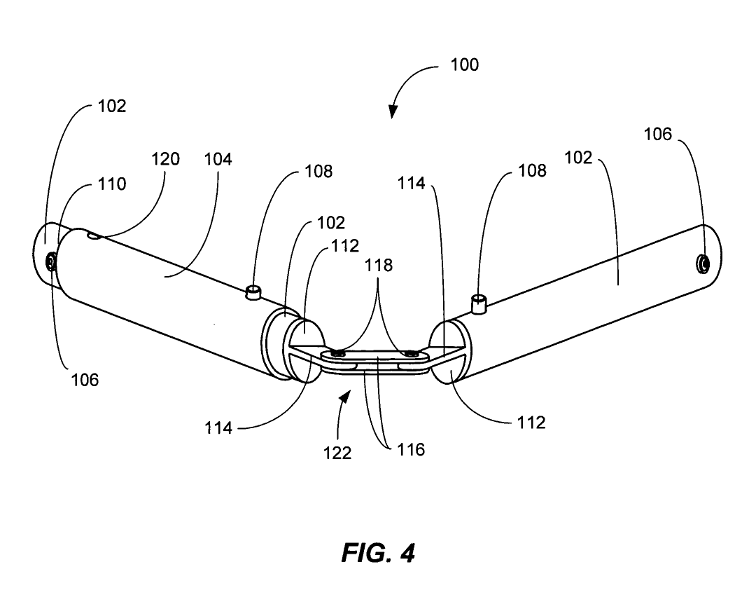

Distinctive features of folding slider joint 200 include the two slider travel stops 106 and the absence of detent mechanisms 108 (FIGS. 1 and 4 of folding slider joint 100). The slider travel stop 106 shown on the left hand side of FIG. 3 defines the furthest point for which the hollow slider 104 can be moved over the left elongated member 102 in the folded position. Once the end 110 of hollow slider 104 abuts slider travel stop 106, the dual pivot mechanism is fully exposed and can be selectively pivoted about each of the binding screws 118. In the folded position, each elongated member 102 may be brought into parallel contact through the dual pivot linkage 122. This facilitates travel and storage of the pole structure including the folding slider joint 200. The right hand side slider travel stop 106 is located closer to the end cap 112 of its associated elongated member. When the hollow slider 104 abuts the right hand side slider travel stop 106, the folding slider joint is in the rigid deployed position.

Binding screws 118 may be configured to allow tabs 114 to pivot around the centers of the tab holes at the binding screws 118. According to other embodiments of folding slider joint 200, other types of rotational members may be used instead of binding screws 118, for example and not by way of limitation, rivets, chain link pins, bearings and the like. While single tabs emanating from the base of each end cap 112 and dual, parallel linking members 116 are shown in the embodiment of folding slider joint 200 of FIG. 3, alternative embodiments are also contemplated. For example and not by way of limitation, dual, parallel tabs 114 emanating from the base of each end cap 112 surrounding a single linking member 116 and secured with two binding screws 118 would be an equivalent structure in an alternative embodiment of folding slider joint 200 or 100 of the present invention.

FIG. 4 is a perspective view of an embodiment of a folding slider joint 100 with detent mechanisms 108 in a folded position according to the present invention. Folding slider joint 100 may include two elongated members 102. Two end caps 112 may be disposed at the ends of the two elongated members 102. Each end cap 112 may have a tab 114 extending from the base of end cap 112. A distal end of each tab 114 may contain a hole for receiving a binding member such as binding screw 118. Folding slider joint 100 may further include at least one linking member 116 (two shown in FIG. 4). Binding screws 118 may be used to secure linking members 116 to end cap 112 tabs 114, just as in folding slider joint 200 (FIG. 3).

Referring generally to FIGS. 1-4, embodiments of a folding slider joint 100 and 200 for rigidly joining two elongated members, may include two end caps 112 configured for placement on ends of the two elongated members 102 and configured for dual pivoting linkage 122 with each other. Embodiments of a folding slider joint 100 and 200 may further include a hollow slider 104. The hollow slider 104 may be configured with an inside dimension configured for concentrically surrounding the elongated members 102 and end caps in a rigid deployed position. The fit between hollow slider 104 and the concentrically surrounded elongated members 102 may be a friction or “interference” fit or a “loosely sliding” fit according to embodiments of the present invention.

Embodiments of a folding slider joint 100 and 200 may further include at least one slider travel stop 106 on an outside surface of an elongated member 102. According to one embodiment, the slider travel stop 106 may be located in a position to limit the travel of the hollow slider 104 to the rigid deployed position, see e.g., FIG. 2, where the slider travel stop 106 located on the right side abuts the end 110 of hollow slider 104. According to another embodiment, the slider travel stop 106 may be located in a position to prevent the hollow slider 104 from traveling further along a given elongated member 102, see e.g., FIG. 3, where the slider travel stop 106 located on the left side abuts the end 110 of hollow slider 104.

Embodiments of a folding slider joint 100 and 200 may include two slider travel stops 106, a first slider travel stop 106 located on an outside surface of one of the two elongated members 102 and defining the rigidly deployed position when the hollow slider abuts the first slider travel stop 106, a second slider travel stop 106 on an outside surface of another of the two elongated members 102 and defining a foldable position when the hollow slider 104 abuts the second slider travel stop 106, see e.g., FIGS. 1-4, which illustrate the use of both slider travel stops 106.

Embodiments of a folding slider joint 100 may include at least one detent mechanism 108 for selectively locking the hollow slider 104 over one of the two elongated members 102 in a foldable position, see e.g., FIG. 4. Embodiments of a folding slider joint 100 may include at least one detent mechanism 108 in the first of two elongated members 102 for selectively locking the hollow slider 104 over the two end caps 112 of the folding slider joint 100 in the rigid deployed position, see e.g., FIG. 1. According to one embodiment of folding slider joint 100, the detent mechanism 108 may be a spring-loaded plunger pin within the first elongated member 102, the plunger pin aligned with a first hole in the first elongated member and configured for alignment with a second hole (or detent hole 120, FIG. 4) in the hollow slider 104 when in the rigid deployed position. Spring-loaded plunger pins are well known in the art, see e.g., U.S. Pat. No. 6,213,672 to Varga.

Another embodiment of folding slider joint 100 may include a second detent mechanism 108 comprising a second spring-loaded plunger pin within a second of the two elongated members 102, the second spring-loaded plunger pin aligned with a third hole in the second elongated member and configured for alignment with a fourth hole in the hollow slider 104 when in the rigid deployed position.

Still another embodiment of folding slider joint 100 may include a first distance measured between the first and third holes when the two end caps of the folding slider joint are in tension in the rigid deployed position that is slightly greater than a second distance measured between the second and fourth holes of the hollow slider, thereby offloading compressive or tensile forces from the dual pivoting linkage 122 of the two end caps 112 to the hollow slider 104 and the two elongated members 102. Yet another embodiment of folding slider joint 100 may include a first distance measured between the first and third holes when the two end caps of the folding slider joint are in compression in the rigid deployed position that is slightly less than a second distance measured between the second and fourth holes of the hollow slider 104, thereby offloading compressive or tensile forces from the dual pivoting linkage 122 of the two end caps 112 to the hollow slider 104 and the two elongated members 102.

According to an embodiment of folding slider joint 100, the dual pivoting linkage 122 may include tabs 114 extending from each end cap 112 and at least one linking member 116 configured for rotational attachment to each tab 114. According to a further embodiment of folding slider joint 100, each tab 114 may include a hole (not shown for clarity) in a distal end of the tab 114. The hole may be configured for rotationally attaching the tab 114 a linking member 116. According to an alternative embodiment of folding slider joint 100, each of the two end caps 112 may further include two parallel tabs (not shown in the FIGS.) extending from each end cap with aligned holes in distal ends of the parallel tabs, the aligned holes configured for rotational attachment to at least one linking member 116. The parallel tabs may be configured to be spaced apart by a distance of approximately the thickness of the linking member 116 received therein, according to an embodiment of the present invention. Other embodiments may include two or more linking members 116.

According to embodiments of folding slider joint 100, the two elongated members 102 and the hollow slider 104 may be formed of any suitable material including but not limited to aluminum, titanium, steel, fiberglass, graphite and graphite composite materials. Of course, the elongated members 102 and hollow slider 104 need not be made of the same materials. According to embodiments of folding slider joint 100 and 200, a cross-section of an outer surface of the two elongated members 102 may be any suitable shape, for example and not by way of limitation, such shapes as: circle, oval, ellipse, triangle, square, pentagon, hexagon, octagon and polygon.

According to still another embodiment of folding slider joint 200, one of the two elongated members 102 may include an outer surface configured with increasing diameter along a direction opposite an end cap 112, the increasing diameter configured to provide a friction tight or interference fit with the inner surface of the hollow slider 104 in the rigid deployed position. The use of a friction or interference fit is an alternative embodiment to using a detent mechanism 108 to lock the hollow slider 104 over the end caps 112.

According to embodiments of folding slider joint 100 and 200, the two elongated members 102 may be hollow. According to further embodiments of folding slider joint 100 and 200, with hollow elongated members 102 the two end caps 112 may be configured for placement within the ends of the two hollow elongated members. According to other embodiments of folding slider joint 100 and 200, the two elongated members 102 may be solid and configured to receive end caps at ends of the elongated members 102.

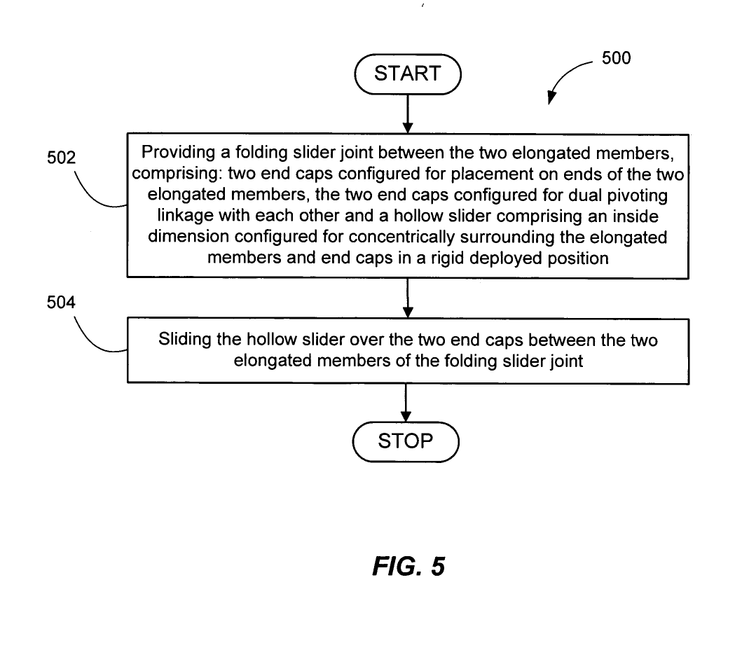

FIG. 5 is a flow chart of a method 500 of deploying a folding slider joint 100 and 200 between two elongated members 102. Method 500 may include providing 502 a folding slider joint 100 and 200 between the two elongated members. According to this method embodiment, the folding slider joint 100 and 200 may be any one of the embodiments disclosed herein, including a hollow slider 104, two end caps 112 on ends of two elongated members 102. Method 500 may further include sliding 504 the hollow slider 104 over the two end caps 112 between the two elongated members 102 of the folding slider joint 100 and 200. Method 500 may further include locking the hollow slider 104 in place over the two end caps 112.

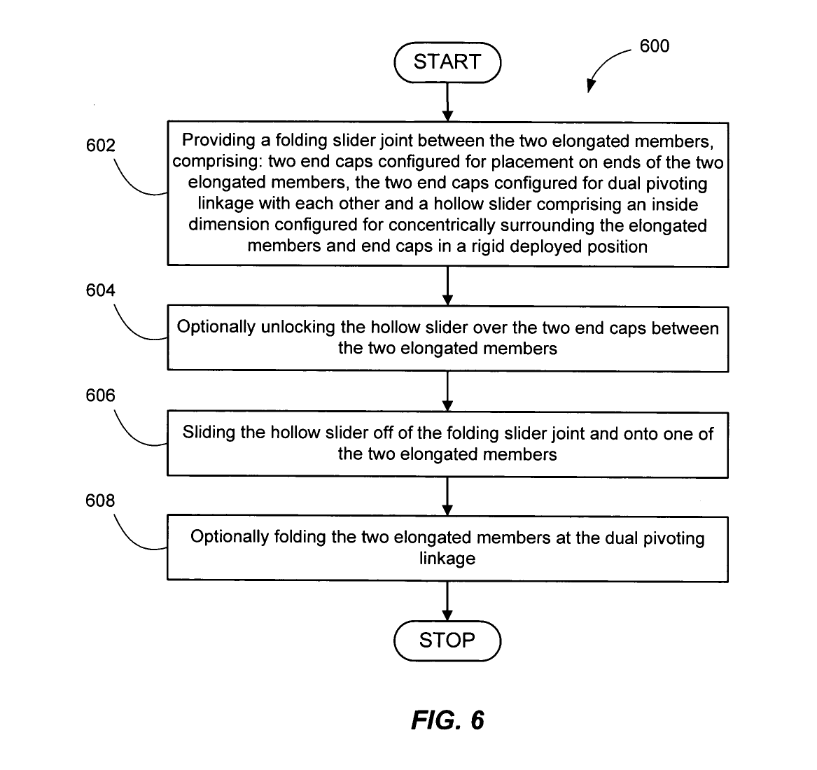

FIG. 6 is a flow chart of a method 600 of collapsing a deployed folding slider joint 100 and 200 between two elongated members 102. Method 600 may include providing 602 a folding slider joint 100 and 200 as described herein. For example folding slider joint 100 and 200 may include two end caps 112 configured for placement on ends of the two elongated members 102 and configured for dual pivoting linkage 122 with each other. Folding slider joint 100 and 200 may further include a hollow slider 104 comprising an inside dimension configured for concentrically surrounding the elongated members 102 and end caps 112 in a rigid deployed position.

Method 600 may further include optionally unlocking 604 the hollow slider 104 over the two end caps 112 between the two elongated members 102. Optionally unlocking 604 the hollow slider 104 may include pushing a detent pin to unlock the hollow slider 104 from an elongated member 102 within the hollow slider 104, thereby allowing the hollow slider 104 to slide concentrically with the elongated members 102 inside the hollow slider 104, according to an embodiment of method 600. Method 600 may further include sliding 606 the hollow slider 104 off of the folding slider joint 100 and 200 and onto one of the two elongated members 102. Method 600 may further include optionally folding 608 the two elongated members 102 at the dual pivoting linkage 122.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A folding slider joint for rigidly joining two elongated members, comprising:
two end caps configured for placement on ends of the two elongated members and configured for dual pivoting linkage with each other; and
a hollow slider comprising an inside dimension configured for concentrically surrounding the elongated members and end caps in a rigid deployed position.

2. The folding slider joint according to claim 1, further comprising at least one slider travel stop on an outside surface of an elongated member.

3. The folding slider joint according to claim 1, further comprising two slider travel stops, a first slider travel stop located on an outside surface of one of the two elongated members and defining the rigidly deployed position when the hollow slider abuts the first slider travel stop, a second slider travel stop on an outside surface of another of the two elongated members and defining a foldable position when the hollow slider abuts the second slider travel stop.

4. The folding slider joint according to claim 1, further comprising at least one detent mechanism for selectively locking the hollow slider over one of the two elongated members in a foldable position.

5. The folding slider joint according to claim 1, further comprising at least one detent mechanism in a first of the two elongated members for selectively locking the hollow slider over the two end caps of the folding slider joint in the rigid deployed position.

6. The folding slider joint according to claim 5, wherein the at least one detent mechanism comprises a spring-loaded plunger pin within the first elongated member, the plunger pin aligned with a first hole in the first elongated member and configured for alignment with a second hole in the hollow slider when in the rigid deployed position.

7. The folding slider joint according to claim 6, further comprising a second detent mechanism comprising a second spring-loaded plunger pin within a second of the two elongated members, the second spring-loaded plunger pin aligned with a third hole in the second elongated member and configured for alignment with a fourth hole in the hollow slider when in the rigid deployed position.

8. The folding slider joint according to claim 7, wherein a first distance measured between the first and third holes when the two end caps of the folding slider joint are in tension in the rigid deployed position is slightly greater than a second distance measured between the second and fourth holes of the hollow slider, thereby offloading compressive or tensile forces from the dual pivoting linkage of the two end caps to the hollow slider and the two elongated members.

9. The folding slider joint according to claim 7, wherein a first distance measured between the first and third holes when the two end caps of the folding slider joint are in compression in the rigid deployed position is slightly less than a second distance measured between the second and fourth holes of the hollow slider, thereby offloading compressive or tensile forces from the dual pivoting linkage of the two end caps to the hollow slider and the two elongated members.

10. The folding slider joint according to claim 1, wherein the dual pivoting linkage comprises tabs extending from each end cap and at least one linking member configured for rotational attachment to each tab.

11. The folding slider joint according to claim 1, wherein each of the two end caps further comprises a tab extending from each end cap and a hole in a distal end of the tab configured for rotational attachment to at least one linking member.

12. The folding slider joint according to claim 1, wherein each of the two end caps further comprises two parallel tabs extending from each end cap with aligned holes in distal ends of the parallel tabs, the aligned holes configured for rotational attachment to at least one linking member.

13. The folding slider joint according to claim 12, wherein the at least one linking member comprises two linking members.

14. The folding slider joint according to claim 1, wherein the two elongated members and the hollow slider comprise at least one of: aluminum, titanium, steel, fiberglass, graphite and graphite composite.

15. The folding slider joint according to claim 1, wherein one of the two elongated members includes an outer surface configured with increasing diameter along a direction opposite an end cap, the increasing diameter configured to provide a friction tight fit with the inner surface of the hollow slider in the rigid deployed position.

16. The folding slider joint according to claim 1, wherein a cross-section of an outer surface of the two elongated members comprises a shape selected from the group consisting of: circle, oval, ellipse, triangle, square, pentagon, hexagon, octagon and polygon.

17. The folding slider joint according to claim 1, wherein the two elongated members are hollow.

18. The folding slider joint according to claim 17, wherein the two end caps are configured for placement within ends of the two hollow elongated members.

19. A method of deploying a folding slider joint between two elongated members, comprising:
providing a folding slider joint between the two elongated members, comprising:
two end caps configured for placement on ends of the two elongated members, the two end caps configured for dual pivoting linkage with each other; and
a hollow slider comprising an inside dimension configured for concentrically surrounding the elongated members and end caps in a rigid deployed position; and
sliding the hollow slider over the two end caps between the two elongated members of the folding slider joint.

20. The method according to claim 19, further comprising locking the hollow slider in place over the two end caps.

21. A method of collapsing a deployed folding slider joint between two elongated members, comprising:
providing a folding slider joint, comprising:
two end caps configured for placement on ends of the two elongated members and configured for dual pivoting linkage with each other; and
a hollow slider comprising an inside dimension configured for concentrically surrounding the elongated members and end caps in a rigid deployed position;
optionally unlocking the hollow slider over the two end caps between the two elongated members;
sliding the hollow slider off of the folding slider joint and onto one of the two elongated members; and
optionally folding the two elongated members at the dual pivoting linkage.

22. The method according to claim 21, wherein optionally unlocking the hollow slider comprises pushing a detent pin to unlock the hollow slider from an elongated member within the hollow slider, thereby allowing the hollow slider to slide concentrically with the elongated members inside the hollow slider.
